(19) United States
(12) Patent Application Publication
(10) Pub. No.: US 2026/0119043 A1
(43) Pub. Date: Apr. 30, 2026

(54) CONFIGURATION TOKEN FOR MEMORY PPPM POWER RING

(71) Applicant: Micron Technology, Inc., Boise, ID (US)

(72) Inventors: Leon Zlotnik, Camino, CA (US); Liang Yu, Boise, ID (US)

(21) Appl. No.: 19/366,076

(22) Filed: Oct. 22, 2025

Related U.S. Application Data
(60) Provisional application No. 63/713,864, filed on Oct. 30, 2024.

(51) Int. Cl. G06F 3/06

(52) U.S. Cl. CPC G06F 3/0611; G06F 3/0634; G06F 3/0679

(57) ABSTRACT

A memory system includes multiple NAND dies connected via a first bus for power data transmission. A processor sends memory access commands over a second bus and generates a service token to initiate power management configuration in the dies. It creates service data to set power parameters and uses a control protocol to determine bus access. Upon access, the processor transmits the token and data over the first bus, enabling real-time updates to the dies' power settings. This system allows efficient power management, adapting to operational demands and environmental conditions.

### PRIORITY APPLICATION

This application claims the benefit of priority to U.S. Provisional Application Ser. No. 63/713,864, filed Oct. 30, 2024, which is incorporated herein by reference in its entirety.

### TECHNICAL FIELD

Embodiments pertain to memory management systems and, in some examples, to peak power management in memory devices such as NAND flash memory devices.

### BACKGROUND

Memory devices for computers or other electronic devices may be categorized as volatile and non-volatile memory. Volatile memory requires power to maintain its data, and includes random-access memory (RAM), dynamic random-access memory (DRAM), Static Random Access Memory (SRAM), or synchronous dynamic random-access memory (SDRAM), among others. Non-volatile memory can retain stored data when not powered, and includes flash memory, read-only memory (ROM), electrically erasable programmable ROM (EEPROM), erasable programmable ROM (EPROM), resistance variable memory, phase-change memory, storage class memory, resistive random-access memory (RRAM), and magnetoresistive random-access memory (MRAM), among others.

Memory devices may interface with a host, such as a processor or another computing device, to store essential data, commands, and instructions. The connection between the host and memory devices can be established via a local bus or interconnect (e.g., the system bus), allowing the memory devices to function within the host's system such as within a traditional computing device. Alternatively, memory devices can be configured within a distributed memory system, which involves a network of interconnected hosts and memory devices which may span across multiple locations. This configuration enables the creation of expansive systems that harness the collective resources of numerous hosts and memory devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a timing diagram of a PPM bus, illustrating the interaction between three controller instances and three NAND dies according to some examples of the present disclosure.

FIG. 2 shows a timing diagram of a PPM bus used to configure PPM parameters of multiple dies in the system according to some examples of the present disclosure.

FIG. 3 illustrates an example computing environment including a memory system, in accordance with some examples of the present disclosure.

FIG. 4 shows a flowchart of a method involving a controller transmitting a configuration change over the PPM bus according to some examples of the present disclosure.

FIG. 5 shows a flowchart of a method involving a NAND die receiving a service token and configuring PPM parameters based upon the service data.

FIG. 6 illustrates a multi-die package with multiple memory dies in a memory sub-system.

FIG. 7 illustrates a block diagram of an example machine 700 upon which any one or more of the techniques (e.g., methodologies) discussed herein may be performed.

FIG. 8 illustrates a block diagram of a computing system according to some examples of the present disclosure.

### DETAILED DESCRIPTION

In certain computing devices, managing power consumption is important. For example, in devices with batteries, managing power usage helps maximize operating time while minimizing battery size and cost. In large server systems, managing power usage can minimize expensive electrical bills and will also still deliver optimal performance. System designers typically approach these problems by allocating power budgets to each component, including memory devices. The components then attempt to maximize performance within the power budget. Once the budget has been exceeded, the device may reduce performance or delay operations until later.

For computing devices that feature multiple components whose power is to be managed (such as a memory device with multiple memory dies), this process may become complicated. Methods to deal with this process have been developed and are referred to herein as Peak Power Management (PPM) methods. For example, a memory system may utilize a PPM communication bus that allows dies and a controller to communicate with each other to limit and/or monitor the current or power consumed by each die. In such a system, each die may incorporate a PPM component that leverages the PPM communication bus to exchange information with its local media controller (e.g., NAND controller) and PPM components on other dies. A PPM component can be set up to perform power or current budget arbitration for its respective die or other device, subsystem, or component.

In some examples, the PPM communication bus may employ a communication protocol that utilizes a token-based round robin method, allowing each PPM component to take turns as the holder of a PPM communication token according to a token circulation time period. A die counter may be utilized to track the current communication token holder and the token's circulation among the memory devices can utilize a common clock signal (“ICLK”). For instance, each die may possess the token—and thus the ability to transmit on the communication bus, for a specific number of clock cycles. The memory device transfers the token to the next component once the number of clock cycles has passed. The clock signal may be provided by a designated primary die. In other examples, other bus protocols may be used.

When a die holds the communication token, its PPM component may broadcast the current power usage information of that die to others, using a data line, such as a high current (HC #) line. This information is transmitted modulating the logic level of the data line signal during a clock cycle. The amount of information that can be transmitted in one transmission is related to the number of clock cycles that each die gets before it must relinquish the token and the modulation scheme. For instance, with a simple modulation scheme where a ‘1’ is represented by pulling the data line high or low, and if the token circulates after three clock cycles, the broadcast allows for three bits to be transmitted for each component.

In some examples, other dies monitor these transmissions and use them to determine how much power in the budget is left. If the amount of power that is left from the budget is greater than the amount that is needed for a pending operation, the die can execute the pending operation and indicate on the PPM bus the amount of power that the die is taking.

Power for memory array operations (such as reads, writes, erases) are typically managed by the PPM protocol, but data path operations are not. To address this, some systems have controllers provide real-time current consumption information for data path operations on the PPM communication bus, allowing for more efficient management. The controller may sit on the PPM communication bus and act similar to a die in broadcasting its current usage.

In some examples, the PPM systems described above configure each system component (e.g., NAND die) with multiple parameters such as token weight (current) and power budget over a bus different from the PPM communication bus, such as the Open NAND Flash Interface Group (ONFI) bus. This is the same bus used to send commands from the NAND controller to the NAND dies. Frequent reconfigurations over the ONFI bus take significant resources that must be synchronized with each other. For example, changing the power budget should be atomic across components, which is not always possible using the ONFI bus. Consider an example with four ONFI channels. Even if the configuration change is broadcast on one channel there's no guarantee that a broadcast can be sent at the same time on the other three channels.

The process of configuring the parameters over a bus such as ONFI is time-consuming as it involves configuring potentially hundreds of dies. This latency causes memory device designers to prioritize methods of power management that do not change these parameters often. This leads to inefficiencies in power management as these parameters may need to be changed in real-time as device power changes. For example, the system cannot quickly adjust to varying operational demands or environmental conditions such as temperature increases or decreases. Consequently, the inefficiency in managing power dynamically limits the potential for performance enhancements and increases the complexity of firmware design in memory systems.

Disclosed in some examples are methods, memory devices, and machine-readable mediums for efficient peak power management in memory systems. The disclosed techniques utilize the PPM bus to configure PPM parameters of the NAND dies in addition to broadcasting information about power consumption rather than using the OFNI bus to configure the parameters. This configuration is facilitated by using a special service token sent by the controller across the PPM bus. Unlike prior art systems that utilized the traditional Open NAND Flash Interface Working Group (ONFI) bus, which requires synchronization of all dies, which may be difficult and time consuming to do given the workload on the ONFI bus, the PPM bus allows each NAND die to receive configuration updates simultaneously and synchronously. This reduces latency in changing PPM parameters, enabling the system to quickly adapt to operational demands and environmental changes, such as temperature fluctuations. This capability enhances dynamic performance optimization, reducing latency and improving overall efficiency.

The service token transmitted across the PPM bus to configure one or more of the dies is sent by a controller over the PPM bus. The service token is sent by the controller when it is the controller's turn to transmit, that is, when the controller has the communication token. The size of the service token may be prespecified, and in response to receiving the service token, the dies enter a service state and waits to receive service information. In some examples, the service token size may not be prespecified and the contents therein may be variable. The service token may include a specific bit sequence identifying the token as a service token. While the service token may be used for configuration of parameters, such as power management parameters, the system may utilize the service token for sending of status requests and other management tasks.

The size of the service information sent after the service token may be prespecified or may be specified in the service token. In some examples, the service token and service information may be the same number of clock cycles as normally allocated to the controller for power information. In other examples, the service information is more or less bits than may be transmitted in the normal clock cycles allocated to the controller and the service token signals dies on the PPM bus that the controller will take more clock cycles than allocated and that future transmissions will be delayed.

The service token acts as a signal that prompts each die to enter a service mode. Once in this mode, the dies can receive updated PPM parameters directly from the PPM bus in, e.g., the service information. This process eliminates the need for the dies to be idle during configuration, as was necessary with the traditional ONFI bus. By allowing for real-time updates, the system can quickly adapt to changes in operational demands and environmental conditions. In other examples, the service information may request status, which may be provided by each die during their next turn to transmit on the PPM bus.

In some examples, rather than being issued by the controller, the service token and/or the service data may be issued by a NAND master-die. In some examples, where the controller does not have updated PPM configurations or power allocations, it may send a skip packet on the token ring that takes fewer clock cycles than normally allocated for the controller that signals the other dies to skip the controller's turn on the PPM bus.

Example parameters configured and requests sent through this method include configuring the power budget, a request to output a power token with the current power usage of the die, a request to output a thermal token with the current temperature of the die, a request to output status information (e.g., what state the die is in and what the progress of current operations are), a Logical Unit (LUN) status, phase slice info (e.g., program pulse, program verify, etc. . . . ), a packet with predefined data to check the status of the PPM bus, enable or disable power throttling, specific operation throttling (e.g., throttling reads, writes, or both), setting a LUN priority to determine which LUN has priority in cases where the power budget is not enough to complete operations on multiple LUNs, and the like.

In some examples, the service information may be status requests, other control messages, and other communications between the controller and the NAND dies. For example, all dies may be instructed to transmit their telemetry status. Then, each component may reply with its status when it is the components turn to transmit over the PPM bus. In some examples, the configuration, status, and/or control messages may be broadcast to all components on the PPM bus, in other examples, the messages may be transmitted to only certain components.

As used herein, a communication token is the token used to determine which component of the memory system is authorized to place data on the PPM bus whereas the service token is used to describe a value placed upon the PPM bus to indicate that the dies on the bus should enter a service mode.

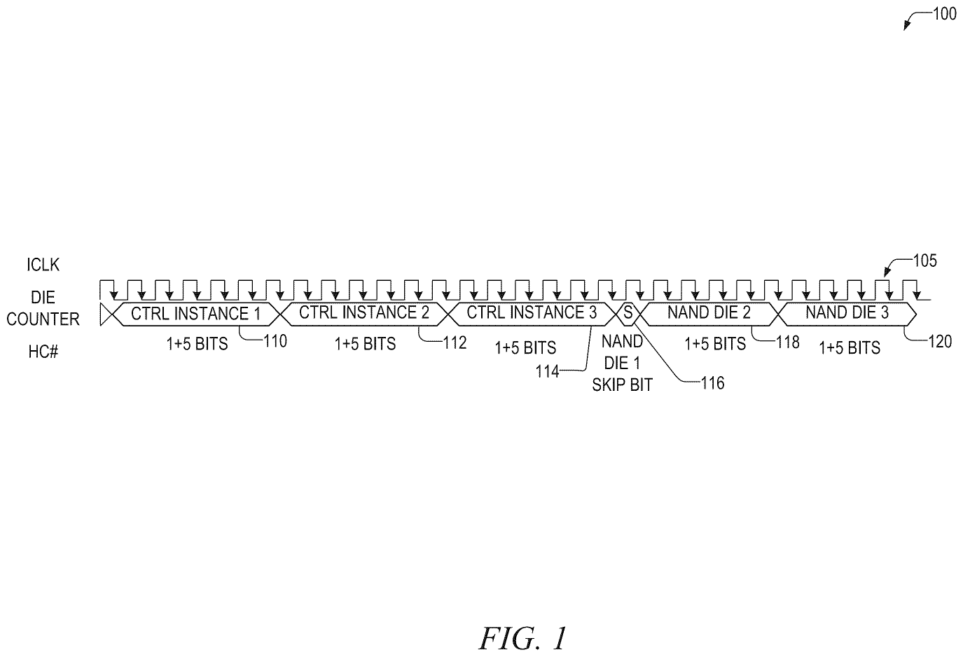

FIG. 1 shows a timing diagram of a PPM bus 100, illustrating the interaction between three controller instances and three NAND dies. The diagram highlights the transmission sequence and the role of each component in the system. The controller instances may be different controllers or simply extra turns for a single controller instance to ensure that the controller is prioritized. The Clock 105 provides the timing signal for the entire system, ensuring synchronized operations across all components. The die counter tracks the current token holder, facilitating the orderly transmission of data among the controller instances and NAND dies. Controller instance 1 110 initiates the sequence by transmitting a 1+5 bits data packet. This transmission is followed by controller instance 2 112, which also sends a 1+5 bits data packet. Controller instance 3 114 continues the sequence with another 1+5 bits data packet.

NAND Die 1 sends a skip bit 116 that indicates it has no data to send. This action is part of the skip bit policy, allowing the components of the system to skip their turn to transmit which efficiently manages the token-ring bus without unnecessary data transmissions. NAND Die 2 transmission 118 resumes the standard data transmission pattern, sending a 1+5 bits data packet. This is followed by NAND Die 3 transmission 120, which also transmits a 1+5 bits data packet, completing the cycle.

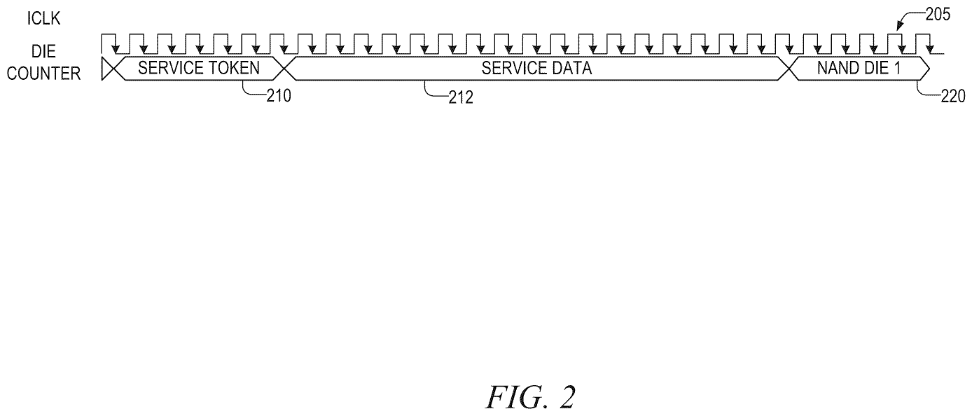

FIG. 2 shows a timing diagram of a PPM bus used to configure PPM parameters of multiple dies in the system. The diagram illustrates the interaction between the clock 205 (shown as ICLK), service token 210, service data 212, and NAND Die 1 220. The clock 205 provides the clock signal that synchronizes the operations across the system. The service token 210 is transmitted over the PPM bus to initiate the service mode in the NAND dies. This token acts as a signal for the dies to prepare for receiving service data. The service token enables simultaneous updates to NAND dies, bypassing the need for serial configuration. Following the service token 210, the service data 212 is transmitted. This data contains the specific PPM parameters that need to be updated in the NAND dies. The configuration data can include various settings such as power budget, current power usage, temperature, status information, and more. As previously disclosed the configuration data 212 may be of a fixed size, a size specified in the configuration token, or may have an ending marked by a special set of bits. Thus the presence of the configuration token 210 signals other components on the PPM bus that the bus is reserved while the configuration data is present. For configuration data 212 that is a request to provide information, the dies provide this information once they obtain the token.

Upon receiving the configuration token and data, the dies enter a configuration mode and update the PPM parameters accordingly. This process allows for efficient and real-time updates to the power management settings of the NAND dies. After the configuration data 212 is transmitted, the token then passes to the next component in the list-which in FIG. 2 is NAND die 1 220.

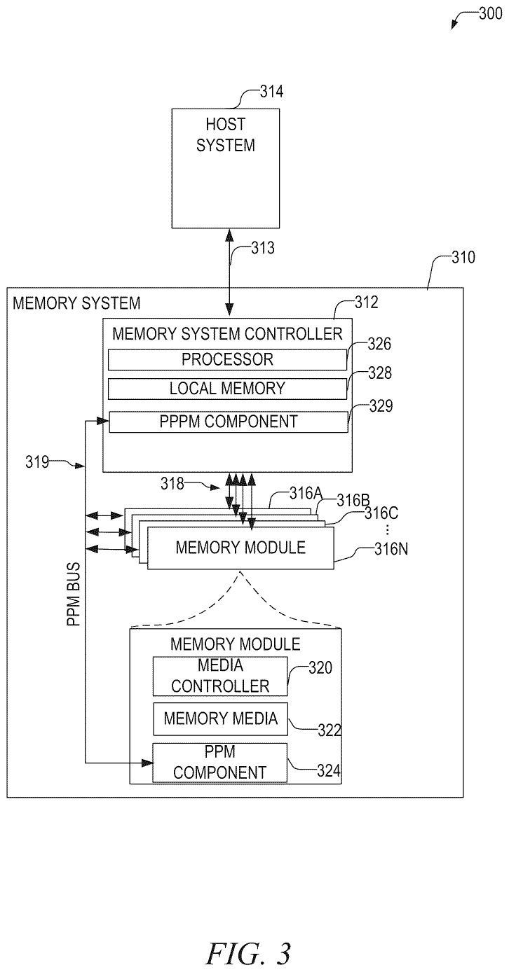

FIG. 3 illustrates an example computing environment 300 including a memory system 310, in accordance with some examples of the present disclosure. In some examples the memory system 310 can be volatile storage such as Random Access Memory (RAM), cache memory, dynamic RAM (DRAM), synchronous DRAM (SDRAM), double data rate SDRAM (DDR), static RAM (SRAM), Graphics DDR (GDDR), or the like. In some examples, the memory system 310 can be non-volatile storage such as a Not-AND (NAND) flash, NOR flash, magnetic storage (e.g., a hard-disk drive), tape storage, or the like. In some examples, the memory system 310 can include both volatile and non-volatile storage, by utilizing, for example, memory modules 316A-N containing different types of memory media 322 or by utilizing one or more single memory modules that include both volatile and non-volatile memory media 322. The memory system 310 may be an error-correcting memory system in that at least some of the memory media 322 includes error correcting memory.

In an example, the memory system 310 can be a discrete memory and/or storage device component of a host system. In other examples, the memory system 310 can be a portion of an integrated circuit (e.g., system on a chip (SOC), etc.), stacked or otherwise included with one or more other components of a host system. In some examples, the memory system 310 may be part of a distributed memory system with multiple memory systems 310 and multiple host systems that may each include one or more processors. For example, a distributed memory system may operate according to a Compute Express Link (CXL) framework, such as a CXL.mem framework. The memory system may also have compute capabilities to support compute-near-memory functionalities—e.g., by using the processor 326 of memory system controller 312, media controller 320, or some other processor that is not shown.

As noted, the host 314, as well as memory system 310 can be integrated into a single host computing system. The host system can be in the form of a desktop computer, laptop computer, network server, mobile device, or such computing device that includes a memory and a processing device. The host system and/or the memory system 310 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 314 and to the memory system 310 so that the host system can read data from or write data to the memory system 310. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 310 is configured with a memory system controller 312 that interfaces with the host 314. The host system 314 may include a hardware processor, which may be a multi-core hardware processor, and communicates with the memory system controller 312 via a memory controller interface 313. Through this interface, the host 314 can issue commands to the memory system controller 312, such as a request to store data, which is accompanied by the data itself and potentially the target memory address for storage. In response, the memory system controller 312 can acknowledge the command and execute the data storage operation, providing confirmation back to the host 314 through the memory controller interface 313. Similarly, the host 314 is capable of sending a command to retrieve data, specifying the memory address from which to load the data. Upon receiving such a command, the memory system controller 312 retrieves the requested data and delivers it to the host 314 through the memory controller interface 313.

In certain embodiments, the host 314 and the memory system controller 312 are integrated onto a single die or different dies, but within a unified package. For example, in systems based on the x86 architecture, the memory system controller 312 is typically on the same die as the processor cores of host 314, thereby streamlining the memory access operations. Alternatively, there are configurations where the memory system controller 312 is situated on a distinct die, separate from that of the host 314 but within a same CPU package, allowing for modular design and potential customization of the memory system. In yet other examples, the memory system controller 312 may not be on the same die or package as the host 314.

The host 314 may communicate with the memory system controller 312 through a memory controller interface 313 and the memory system controller 312 may communicate with one or more memory modules 316A-316N upon which the physical memory is located through the memory module interface 318. In examples in which the memory system controller 312 is not on the same die or package as the host 314, the memory controller interface 313 may be the system bus, front-side bus, or other interface and the memory module interface 318 may be an internal bus of the memory system 310, such as internal pins or traces or some other interface such as an ONFI bus. In other examples, where the memory system controller 312 is on a same die or package as the host 314, the memory controller interface 313 may be one or more traces, pins, or some other interface and the memory module interface 318 may be a system bus.

The memory controller interface 313 and/or the memory module interface 318 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 316A through 316N, are capable of incorporating a diverse array of memory media 322, which may be either volatile or non-volatile in nature. The memory media 322 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 322 within modules 316A-316N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 322 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 322 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 316A-316N may include a media controller 320 that may handle tasks such as accessing data from the memory media, writing data to the memory media, refreshing memory cells and communications over the memory module interface with the memory system controller 312. For example, the media controller 320 can parse a command and determine the affected memory cells from the memory media 322 and can read and/or write a desired value to those memory cells. Media controller 320 can be responsible for refreshing or otherwise maintaining the data stored in the memory media 322. In some examples, the media controller 320 may handle one or more of the functions traditionally associated with the memory system controller 312. In some examples, the memory modules 316A-N do not include a media controller 320.

The media controller 320 can include hardware such as one or more integrated circuits and/or discrete components, a buffer memory, or a combination thereof. The media controller 320 can be a microcontroller, special purpose logic circuitry (e.g., a field programmable gate array (FPGA), an application specific integrated circuit (ASIC), etc.), or other suitable processor(s). The media controller 320 can include a processor (processing device) configured to execute instructions stored in a local memory. Media controller 320 can also include address circuitry, row decoders, I/O circuitry write circuitry, column decoders, sensing circuitry, and other latches for decoding addresses, writing to, and reading from the memory media 322.

The local memory of the media controller 320 can include embedded memory configured to store instructions for performing various processes, operations, logic flows, and routines that control the memory media 322, including handling communications between the memory module 316A-316N and the memory system controller 312. In some embodiments, the local memory of the media controller 320 can include memory registers storing, e.g., memory pointers, fetched data, etc. The local memory can also include read-only memory (ROM) for storing micro-code.

The memory system controller 312 (controller) can include a processor 326 configured to execute instructions stored in a local memory 328. The processor 326 can be a microcontroller, special purpose logic circuitry (e.g., a field programmable gate array (FPGA), an application specific integrated circuit (controller), etc.), general purpose processor configured by software (e.g., firmware), or other suitable processor. In the illustrated example, the local memory 328 may store instructions for performing various processes, operations, logic flows, and routines that control operation of the memory system 310, including handling communications between the memory system 310 and the host 314 and communications between the memory system controller 312 and the memory modules 316A-316N. In some embodiments, the local memory 328 of the memory system controller 312 can include memory registers storing, e.g., memory pointers, fetched data, etc. The local memory can also include read-only memory (ROM) for storing micro-code.

Local memory 328 may also include various management tables such as translation tables translating logical addresses used by the host 314 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 312.

As noted, the memory system controller 312 can receive commands or operations (memory access commands) from the host 314 (or other component of a host) and can convert the commands or operations into instructions or appropriate commands to achieve the desired access to the memory modules 316A to 316N. The memory system controller 312 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 316A to 316N. The memory system controller 312 can further include interface circuitry to communicate with the processor via the memory controller interface 313. The interface circuitry can convert the commands received from the host 314 into command instructions to access the memory modules 316A to 316N over the memory module interface 318 as well as convert responses associated with the memory modules 316A to 316N into information for the host 314 or other component of the host system.

The memory system controller 312 may include or be coupled to a PPM component 329 for configuring dies or sending commands to the one or more memory modules 316A-316N over the PPM bus 319. The PPM component 329 may monitor power usage, temperature, and other operational metrics of the memory system 310 and adjust the die configuration accordingly. The PPM component 329 may send a service token when it has the communication token of the PPM bus 319, followed by a service data. The PPM component 324 of the memory module receives the service token and in response, enters a service state and configures itself, or responds to commands, based upon the service data. In some examples, each memory module 316 may have a PPM component 324. In some examples, each memory module 316 may have multiple dies which may each have a PPM component 324. In some examples, instead of a discrete controller, the functionality of the PPM controller 329 may be implemented by a component—e.g., a hardware or software component.

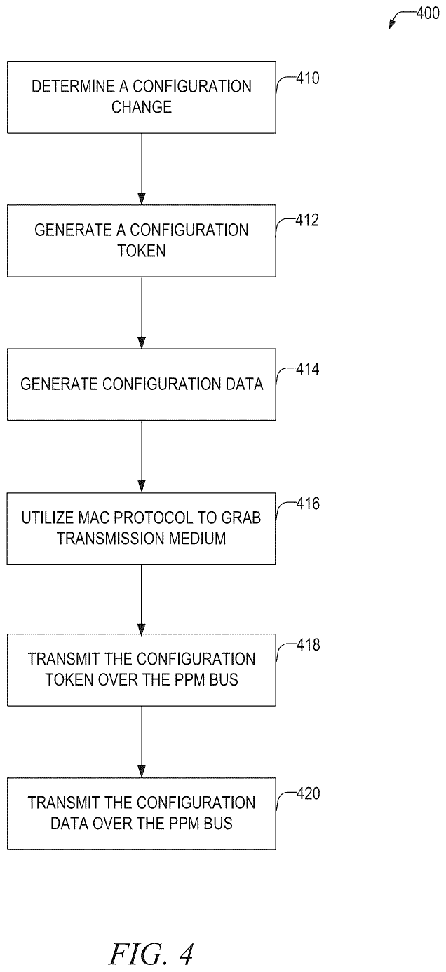

FIG. 4 shows a flowchart of a method 400 involving a controller transmitting a configuration change over the PPM bus according to some examples of the present disclosure. The method begins with determining a configuration change at operation 410. This step involves identifying the need for a modification in parameters of the NAND dies or other components. Example parameters may include power management parameters. For example, the memory device may receive a change in power parameters from a host or the memory device may assess operational demands and environmental conditions and determine an adjustment is necessary. Factors such as changes in temperature, power consumption patterns, battery remaining life, or performance requirements may trigger the need for a configuration update. The controller evaluates these conditions to decide when a modification is required, ensuring optimal power management and system efficiency.

Following the determination that a change is indicated, the controller generates (creates) a service token at operation 412. This token serves as a signal to the NAND dies, indicating the initiation of a service mode (e.g., a configuration mode). The service token synchronizes the subsequent steps in the process. Next, the controller generates (e.g., creates) service data at operation 414. This information contains the specific data required to update the parameters, such as power management parameters or other commands. The service data is prepared to ensure that all necessary information is included for the configuration process.

The controller then utilizes the Medium Access Control (MAC) protocol of the bus at operation 416. While the disclosure has described the PPM bus in terms of a token ring network, other bus types such as ethernet, Inter-Integrated Circuit (I2C), Serial, Parallel, Peripheral Component Interconnect (PCI), PCI express (PCI-e), and the like may be used. For a token ring network, the component that has the token may transmit and thus the MAC protocol uses a token to determine which component may transmit. For ethernet, the MAC protocol uses Carrier Sense Multiple Access with Collision Detection (CSMA/CD) to allow multiple devices to fairly share access to a common communication channel by listening for traffic before transmitting and detecting collisions if they occur.

Once the controller has the transmission medium, the controller then transmits the service token over the PPM bus at operation 418. This transmission signals the NAND dies to enter the service mode and prepare to receive the service data. Next, while the controller still has the medium, the service data is transmitted over the PPM bus at operation 420. This step involves sending the prepared service mode data to the NAND dies, allowing them to update their parameters according to the new service data. In some examples, the service data is transmitted within a same transmission opportunity as the service token, but in other examples, the service token is transmitted at a first transmission opportunity and then the service data is transmitted in a later transmission opportunity.

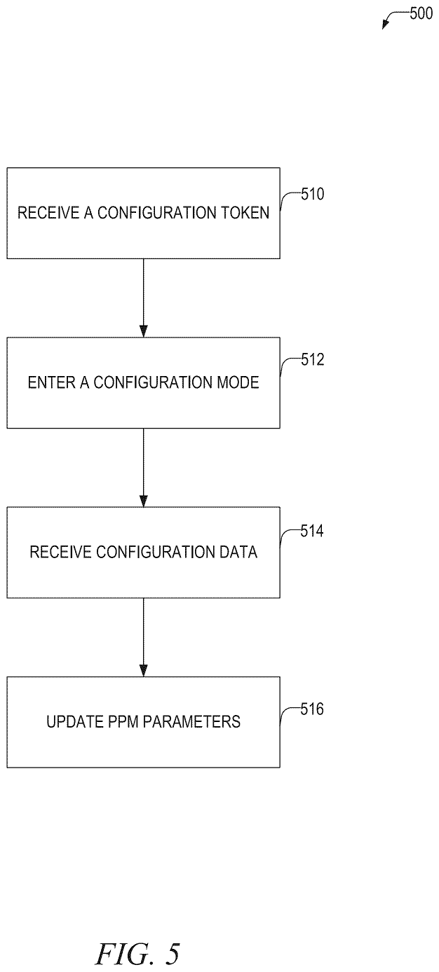

FIG. 5 shows a flowchart of a method 500 involving a NAND die receiving a service token and configuring PPM parameters based upon the service data. The process begins with the NAND die receiving a service token at operation 510 over the PPM bus. This token serves as a signal for the NAND die to prepare for a configuration update. The service token is transmitted over the token-ring bus, indicating that the NAND die enters a service mode.

Upon receiving the service token, the NAND die enters a service mode at operation 512. In this mode, the NAND die is set to receive and process service data. This transition into service mode ensures that the NAND die is ready to update the PPM parameters efficiently.

Following the entry into service mode, the NAND die receives service data at operation 514. This data contains specific PPM parameters that need to be updated. The service data may include settings such as power budget, current power usage, temperature, status information, and other relevant parameters.

Once the service data is received, the NAND die updates the PPM parameters at operation 516. This update allows the NAND die to adjust the power management settings according to the new service data. The process ensures that the NAND die can quickly adapt to changes in operational demands and environmental conditions, enhancing the efficiency of power management within the system.

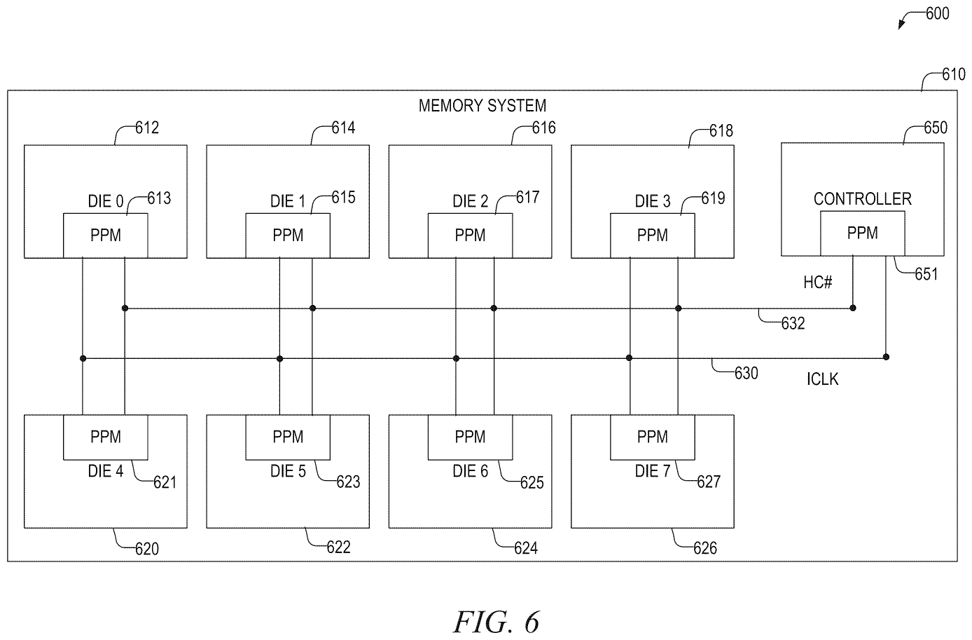

FIG. 6 illustrates a multi-die package 600 with multiple memory dies in a memory sub-system 610. The package includes memory dies 612, 614, 616, 618, 620, 622, 624, 626. These dies share a clock signal ICLK 630 and a data signal HC #632. These signals facilitate synchronized operations and power management across the dies. Each memory die, such as die 612, contains a PPM component, such as PPM 613 that receives the ICLK and HC #signals. Other dies have other PPM components, such as PPM components 615, 617, 619, 621, 623, 625, and 627. A token-based protocol cycles a token through the memory dies to determine and broadcast peak current magnitudes. Each die holds the token for a defined number of clock cycles before passing it on.

The controller 650, featuring PPM 651, manages power by generating and transmitting service tokens over the PPM bus that includes the controller's power usage. This allows for real-time updates to PPM parameters without idling the dies, enabling the system to adapt quickly to changing demands and conditions.

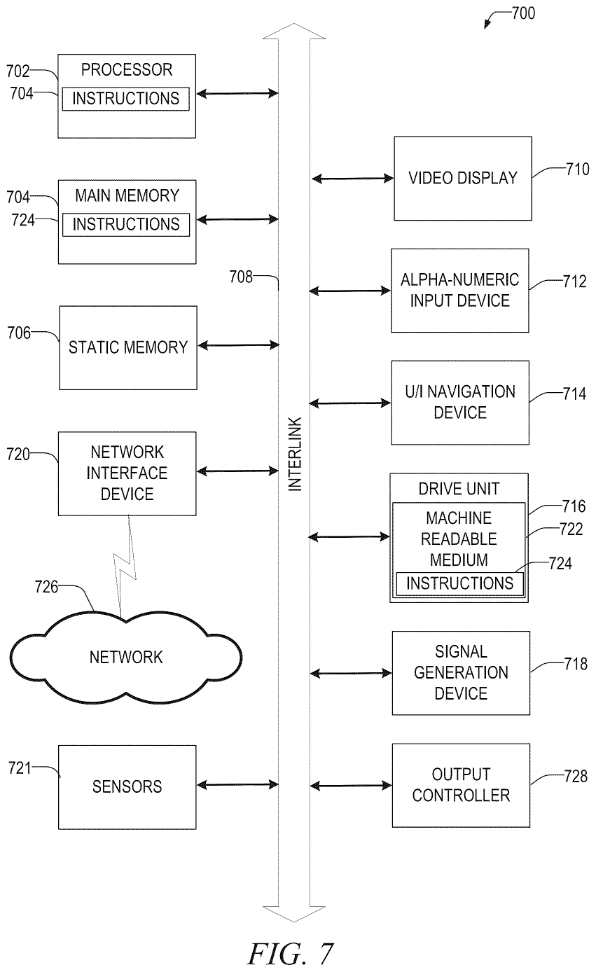

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be in the form of a memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 may be configured to perform, or components of machine 700 may be configured to perform the PPM ringbus shown in FIGS. 1 and 2, be configured as a memory system 310 shown in FIG. 3, the memory system 610 shown in FIG. 6, or perform the methods of FIGS. 4 and 5.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 700 may include one or more hardware processors, such as processor 702. Processor 702 may be a central processing unit (CPU), a graphics processing unit (GPU), a hardware processor core, or any combination thereof. Machine 700 may include a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

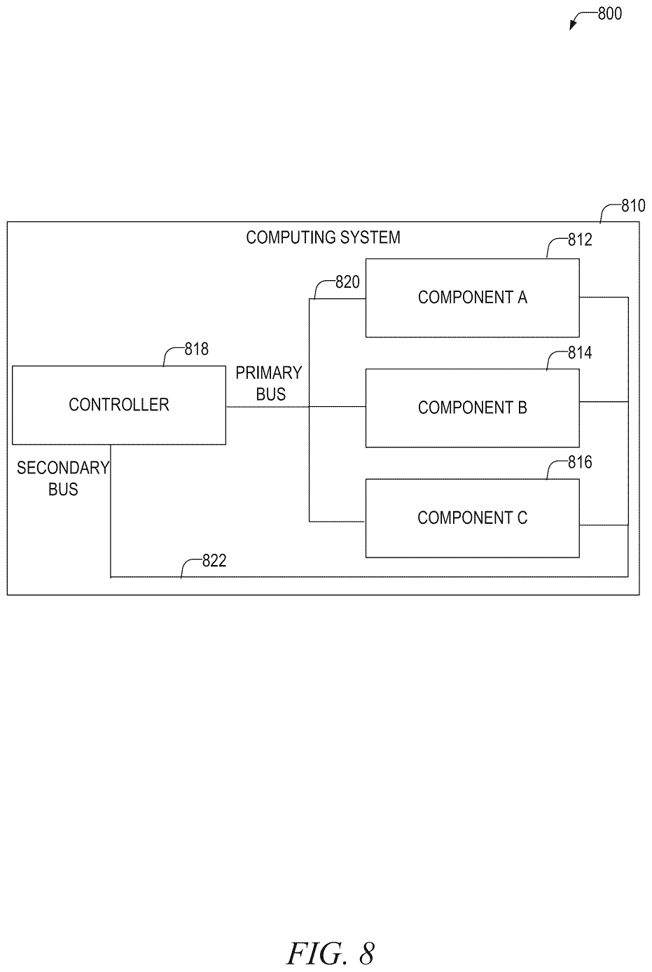

While the present disclosure has described the inventive techniques disclosed herein in the context of memory systems, a person of ordinary skill in the art will appreciate that these inventive techniques may be utilized with other systems as well. FIG. 8 illustrates a computing system 810 with three components: component A 812, component B 814, and component C 816. The three components are connected to a controller 818. The controller configures, receives status information from, and/or manages the components.

The primary bus 820 is a communication bus used primarily by the controller 818 to communicate data and operations with the components. For example, if the components are memory devices, the primary bus 820 may be used to communicate data stored in the memory devices. The controller may use a secondary bus 822, which is also a communication bus, to communicate one or more of status information, management commands, configuration commands, power management commands, or the like. In some examples, the controller 818 may utilize a service mode token to signal a command to the components to enter a service mode and to respond to the request from the controller 818. In some examples, the primary bus 820 sends data to/from the components and the controller 818. In some examples, the secondary bus 822 is used by the components to send power management information to the other components and to controller 818. The secondary bus 822 thus may be repurposed from sending power management information to send configuration, status, and control commands from the controller 818 to the components.

Controller, component A 812, component B 814, and/or component C 816 may be software components or hardware components (e.g., logic circuits such as an Application Specific Integrated Circuit (ASIC)). In some examples, the controller, component A 812, component B 814, and/or component C 816 may be on the same device. In other examples, one or more of the components and the controller 818 may be, or be located on, different devices. In some examples, the communication buses (e.g., either or both of primary bus 820 and secondary bus 822) may be local buses such as Peripheral Component Interconnect (PCI), Universal Serial Bus, memory buses, token ring busses, ethernet busses, and the like. In other examples, the buses may be remote buses such as those facilitating communication between devices. For example, a CXL bus.

The flexibility of this system allows for various configurations and applications beyond memory management. For instance, the components could be sensors in an IoT network, where the controller aggregates data and sends configuration updates based on environmental changes. Alternatively, in a distributed computing environment, the components could be processing units that the controller manages to optimize computational load and power consumption. The use of a service mode token enables efficient reconfiguration without interrupting ongoing operations, making the system adaptable to real-time demands. Furthermore, the ability to repurpose the secondary bus for different types of communication enhances the system's versatility. This feature allows the system to dynamically switch between different operational modes, such as transitioning from data transmission to configuration updates, without requiring additional hardware. This adaptability is particularly beneficial in environments where space and resources are limited, such as in embedded systems or portable devices.

### Other Notes and Examples

Example 1 is a memory system comprising: a plurality of memory dies communicatively coupled with a first communication bus, the first communication bus used to transmit power consumption information; a processor, communicatively coupled with the plurality of memory dies over the first communication bus and a second communication bus, the processor configured to perform operations comprising: sending memory access commands over the second communication bus; generating a service token to cause the plurality of memory dies to enter a power management service mode; generating a service data that sets at least one power management parameter of the plurality of memory dies; determining, using a medium access control protocol, that the processor is able to send data over the first communication bus, and in response: transmitting the service token over the first communication bus; and transmitting the service data after the service token to configure the memory dies according to the service data.

In Example 2, the subject matter of Example 1 includes, wherein each memory die of the plurality of memory dies is configured to: enter a service mode upon receiving the service token; and update power management parameters based on the service data.

In Example 3, the subject matter of Example 2 includes, wherein the plurality of memory dies simultaneously receiving the service token, the service data, and updating the power management parameters based upon the service data.

In Example 4, the subject matter of Examples 1-3 includes, wherein the service data sets at least one of: a power budget, a request to output current power usage, a request to output temperature, a request to output status information, a request to output Logical Unit (LUN) status, or a request to output phase slice information.

In Example 5, the subject matter of Examples 1˜4 includes, wherein the service data enables or disables power throttling for the plurality of memory dies.

In Example 6, the subject matter of Examples 1-5 includes, wherein the processor is further configured to transmit a skip token on the first communication bus when the processor does not have service data to transmit, the skip token signaling the plurality of memory dies to skip the processor's turn on the first communication bus.

In Example 7, the subject matter of Examples 1-6 includes, wherein the service token includes a length of the service data.

Example 8 is a method for configuring power management parameters in a memory system, the memory system including first and second communication buses, the method comprising: using a hardware processor to perform operations comprising: sending memory access commands to one or more of a plurality of memory dies over the second communication bus, the hardware processor communicatively coupled to the plurality of memory dies over the second communication bus; generating a service token to cause a plurality of memory dies to enter a power management service mode; generating service data that sets at least one power management parameter of the plurality of memory dies; determining, using a medium access control protocol, that the processor is able to send data over the first communication bus, the plurality of NAND dies and the hardware processor communicatively coupled over the first communication bus, the first communication bus used to transmit power consumption information; responsive to determining that the processor is able to send data over the first communication bus: transmitting the service token over the first communication bus; and transmitting the service data after the service token to configure the memory dies according to the service data.

In Example 9, the subject matter of Example 8 includes, wherein the method further comprises: at a die of the plurality of dies: entering a service mode upon receiving the service token; and updating power management parameters based on the service data.

In Example 10, the subject matter of Example 9 includes, wherein the plurality of memory dies simultaneously receive the service token, the service data, and update the power management parameters based upon the service data.

In Example 11, the subject matter of Examples 8-10 includes, wherein the service data sets at least one of: a power budget, a request to output current power usage, a request to output temperature, a request to output status information, a request to output Logical Unit (LUN) status, or a request to output phase slice information.

In Example 12, the subject matter of Examples 8-11 includes, wherein the service data enables or disables power throttling for the plurality of memory dies.

In Example 13, the subject matter of Examples 8-12 includes, wherein the method further comprises transmitting a skip token on the first communication bus when the processor does not have service data to transmit, the skip token signalling the plurality of memory dies to skip the processor's turn on the first communication bus.

In Example 14, the subject matter of Examples 8-13 includes, wherein the service token includes a length of the service data.

Example 15 is a non-transitory machine-readable medium, storing instructions for configuring power management parameters in a memory system, the instructions, which when executed, cause a hardware processor of the memory system to perform operations comprising: sending memory access commands to one or more of a plurality of memory dies over the second communication bus, the hardware processor communicatively coupled to the plurality of memory dies over the second communication bus; generating a service token to cause a plurality of memory dies to enter a power management service mode; generating service data that sets at least one power management parameter of the plurality of memory dies; determining, using a medium access control protocol, that the processor is able to send data over the first communication bus, the plurality of NAND dies and the hardware processor communicatively coupled over the first communication bus, the first communication bus used to transmit power consumption information; responsive to determining that the processor is able to send data over the first communication bus: transmitting the service token over the first communication bus; and transmitting the service data after the service token to configure the memory dies according to the service data.

In Example 16, the subject matter of Example 15 includes, wherein the operations further comprise: at a memory die: entering a service mode upon receiving the service token; and updating power management parameters based on the service data.

In Example 17, the subject matter of Example 16 includes, wherein the plurality of memory dies simultaneously receive the service token, the service data, and update the power management parameters based upon the service data.

In Example 18, the subject matter of Examples 15-17 includes, wherein the service data sets at least one of: a power budget, a request to output current power usage, a request to output temperature, a request to output status information, a request to output Logical Unit (LUN) status, or a request to output phase slice information.

In Example 19, the subject matter of Examples 15-18 includes, wherein the service data enables or disables power throttling for the plurality of memory dies.

In Example 20, the subject matter of Examples 15-19 includes, wherein the operations further comprise transmitting a skip token on the first communication bus when the processor does not have service data to transmit, the skip token signalling the plurality of memory dies to skip the processor's turn on the first communication bus.

In Example 21, the subject matter of Examples 15-20 includes, wherein the service token includes a length of the service data.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A memory system comprising:
a plurality of memory dies communicatively coupled with a first communication bus, the first communication bus used to transmit power consumption information;
a processor, communicatively coupled with the plurality of memory dies over the first communication bus and a second communication bus, the processor configured to perform operations comprising:
sending memory access commands over the second communication bus;
generating a service token to cause the plurality of memory dies to enter a power management service mode;
generating a service data that sets at least one power management parameter of the plurality of memory dies;
determining, using a medium access control protocol, that the processor is able to send data over the first communication bus, and in response:
transmitting the service token over the first communication bus; and
transmitting the service data after the service token to configure the memory dies according to the service data.

2. The memory system of claim 1, wherein each memory die of the plurality of memory dies is configured to:
enter a service mode upon receiving the service token; and
update power management parameters based on the service data.

3. The memory system of claim 2, wherein the plurality of memory dies simultaneously receive the service token, the service data, and update the power management parameters based upon the service data.

4. The memory system of claim 1, wherein the service data sets at least one of: a power budget, a request to output current power usage, a request to output temperature, a request to output status information, a request to output Logical Unit (LUN) status, or a request to output phase slice information.

5. The memory system of claim 1, wherein the service data enables or disables power throttling for the plurality of memory dies.

6. The memory system of claim 1, wherein the processor is further configured to transmit a skip token on the first communication bus when the processor does not have service data to transmit, the skip token signaling the plurality of memory dies to skip the processor's turn on the first communication bus.

7. The memory system of claim 1, wherein the service token includes a length of the service data.

8. A method for configuring power management parameters in a memory system, the memory system including first and second communication buses, the method comprising:
using a hardware processor to perform operations comprising:
sending memory access commands to one or more of a plurality of memory dies over the second communication bus, the hardware processor communicatively coupled to the plurality of memory dies over the second communication bus;
generating a service token to cause a plurality of memory dies to enter a power management service mode;
generating service data that sets at least one power management parameter of the plurality of memory dies;
determining, using a medium access control protocol, that the processor is able to send data over the first communication bus, the plurality of NAND dies and the hardware processor communicatively coupled over the first communication bus, the first communication bus used to transmit power consumption information;
responsive to determining that the processor is able to send data over the first communication bus:
transmitting the service token over the first communication bus; and
transmitting the service data after the service token to configure the memory dies according to the service data.

9. The method of claim 8, wherein the method further comprises:
at a die of the plurality of dies:
entering a service mode upon receiving the service token; and
updating power management parameters based on the service data.

10. The method of claim 9, wherein the plurality of memory dies simultaneously receive the service token, the service data, and update the power management parameters based upon the service data.

11. The method of claim 8, wherein the service data sets at least one of: a power budget, a request to output current power usage, a request to output temperature, a request to output status information, a request to output Logical Unit (LUN) status, or a request to output phase slice information.

12. The method of claim 8, wherein the service data enables or disables power throttling for the plurality of memory dies.

13. The method of claim 8, wherein the method further comprises transmitting a skip token on the first communication bus when the processor does not have service data to transmit, the skip token signaling the plurality of memory dies to skip the processor's turn on the first communication bus.

14. The method of claim 8, wherein the service token includes a length of the service data.

15. A non-transitory machine-readable medium, storing instructions for configuring power management parameters in a memory system, the instructions, which when executed, cause a hardware processor of the memory system to perform operations comprising:
sending memory access commands to one or more of a plurality of memory dies over the second communication bus, the hardware processor communicatively coupled to the plurality of memory dies over the second communication bus;
generating a service token to cause a plurality of memory dies to enter a power management service mode;
generating service data that sets at least one power management parameter of the plurality of memory dies;
determining, using a medium access control protocol, that the processor is able to send data over the first communication bus, the plurality of NAND dies and the hardware processor communicatively coupled over the first communication bus, the first communication bus used to transmit power consumption information;
responsive to determining that the processor is able to send data over the first communication bus:
transmitting the service token over the first communication bus; and
transmitting the service data after the service token to configure the memory dies according to the service data.

16. The non-transitory machine-readable medium of claim 15, wherein the operations further comprise:
at a memory die:
entering a service mode upon receiving the service token; and
updating power management parameters based on the service data.

17. The non-transitory machine-readable medium of claim 16, wherein the plurality of memory dies simultaneously receive the service token, the service data, and update the power management parameters based upon the service data.

18. The non-transitory machine-readable medium of claim 15, wherein the service data sets at least one of: a power budget, a request to output current power usage, a request to output temperature, a request to output status information, a request to output Logical Unit (LUN) status, or a request to output phase slice information.

19. The non-transitory machine-readable medium of claim 15, wherein the service data enables or disables power throttling for the plurality of memory dies.

20. The non-transitory machine-readable medium of claim 15, wherein the operations further comprise transmitting a skip token on the first communication bus when the processor does not have service data to transmit, the skip token signaling the plurality of memory dies to skip the processor's turn on the first communication bus.
